(19) United States
(12) Patent Application Publication
(10) Pub. No.: US 2024/0207904 A1
(43) Pub. Date: Jun. 27, 2024

(54) SMOKING APPARATUS CLEANER

(71) Applicant: Greenmarket Enterprises, Inc., Plymouth, MI (US)

(72) Inventor: Peter Lafferty, East Hampton, NY (US)

(73) Assignee: Greenmarket Enterprises, Inc., Plymouth, MI (US)

(21) Appl. No.: 18/487,632

(22) Filed: Oct. 16, 2023

Related U.S. Application Data
(60) Provisional application No. 63/477,005, filed on Dec. 23, 2022.
(60) Provisional application No. 63/508,415, filed on Jun. 15, 2023.

(51) Int. Cl. B08B 3/04; A24F 9/04

(52) U.S. Cl. CPC B08B 3/044; A24F 9/04

(57) ABSTRACT

A structure for cleaning a smoking apparatus includes a first tube, defining a chamber and a first strainer. The chamber is filled with the cleaning solution. The structure generally includes a first cap removably attachable to the first tube and may have a neck formed on the first tube, such that the first cap attaches to the neck. A method of cleaning a smoking apparatus includes, at least, filling a first tube, defining a chamber, with a cleaning solution, and placing the smoking apparatus into the cleaning solution. Agitating the cleaning solution and the smoking apparatus for a period of time. The method may include agitating the cleaning solution and the smoking apparatus occurs via shaking or an oscillating base.

### CROSS-REFERENCE TO RELATED APPLICATIONS

This application claims the benefit of U.S. Provisional Application No. 63/477,005, filed 23 Dec. 2022, and U.S. Provisional Application No. 63/508,415, filed 15 Jun. 2023, both of which are hereby incorporated by reference in their entirety.

### INTRODUCTION

This disclosure generally relates to apparatuses for cleaning devices used for smoking.

### SUMMARY

A structure and method for cleaning a smoking apparatus is provided, and includes a first tube, defining a chamber; a first strainer; and a cleaning solution, wherein the chamber is filled with the cleaning solution. The structure generally includes a first cap removably attachable to the first tube and may have a neck formed on the first tube, such that the first cap attaches to the neck.

The structure may include a first tube and a second tube, slidably movable relative to the first tube, such that a retaining ring joins the first tube to the second tube. There may be a basket into which the smoking apparatus may be placed, and the first tube and the second tube may be filled with a cleaning solution.

A method of cleaning a smoking apparatus, includes: filling a first tube, defining a chamber, with a cleaning solution; placing the smoking apparatus into the cleaning solution; and agitating the cleaning solution and the smoking apparatus for a period of time. The method may include agitating the cleaning solution and the smoking apparatus occurs via shaking or an oscillating base. The method may further include filling the telescoping tube the cleaning solution.

The above features and advantages, and other features and advantages, of the present disclosure are readily apparent from the following detailed description of some of the best modes and other embodiments for carrying out the disclosure, which is defined solely by the appended claims, when taken in connection with the accompanying drawings.

### BRIEF DESCRIPTION OF THE DRAWINGS

FIGS. 1A, FIGS. 1B, and FIGS. 1C, schematically illustrate views of an extendable chamber having two caps: FIG. 1A shows an isometric view of the entire assembly; FIG. 1B shows an isometric view with a base chamber hidden; and FIG. 1C shows an isometric view with a top cap hidden.

FIG. 2A schematically illustrates an isometric view of extendable chamber having a vibrating, spinning, or oscillating base; and FIG. 2B shows an isometric view with a base chamber hidden.

FIG. 3A schematically illustrates a front view of a single chamber larger cup; and FIG. 3B shows a front view of a single chamber smaller cup.

FIGS. 4A and FIGS. 4B show isometric, partially exploded, views of an alternative smoking apparatus.

FIGS. 5A and FIGS. 5B show cross-section views of an alternative smoking apparatus, one of which shows the smoking apparatus.

FIGS. 6A and FIGS. 6B show isometric views of a first strainer and a second strainer, which may be used with an alternative smoking apparatus.

### DETAILED DESCRIPTION

Referring to the drawings, like reference numbers correspond to like or similar components wherever possible throughout the several figures. All figures may be referred to in any section of the specification, without regard to numerical order.

### Extendable Basket with One or More Caps

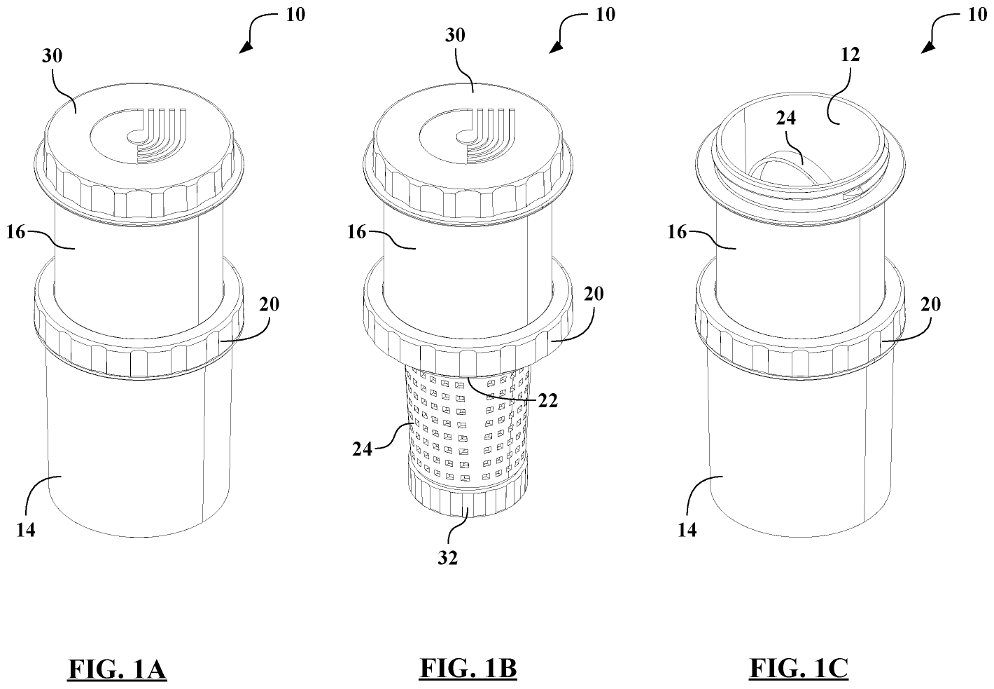

FIGS. 1A, FIGS. 1B, and FIGS. 1C show a smoking apparatus cleaner 10, or simply cleaner 10. This cleaner 10 may use shaking to assist in cleaning the smoking apparatus, not shown, which is placed inside. The cleaner 10 is generally cylindrical, telescoping, and holds the solvent or cleaning solution.

The cleaning solution may be, for example, and without limitation, an all-natural, kosher, environmental, cleaning solvent to clean smoking apparatuses. The cleaning solution, or the smoking apparatus cleaner, may be referred to as RESINCLEANSE or RESIN CLEANSE. The smoking apparatus, or smoking apparatuses, may be of any kind, including, without limitation, tobacco, cannabis, vape devices, or other devices recognizable to those having ordinary skill in the art. Additionally, the smoking apparatus may be formed from, without limitation, metal, glass, or other materials recognizable to skilled artisans. One of the reasons, without limitation, that the smoking apparatus may need to be cleaned may be a buildup of resin caused by use of the smoking apparatus.

When used herein, the term “substantially” often refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%. When used herein, the term “approximately” often refers to relationships where skilled artisans would recognize the amount of coverage needed.

The cleaner 10 in one or more embodiments includes a telescoping chamber 12, which is defined by, at least, a first tube 14 or base chamber and a second tube 16 or top chamber, that give the telescoping chamber 12 and/or telescoping tube variable height and adjustability. Note that the telescoping chamber 12 may, alternatively, be referred to as a two-part telescoping tube 12. A sealing mechanism 20 or retaining ring may join the first tube 14 and the second tube 16. Note that the first tube 14 and the second tube 16 may not be tubular, but may be, without limitation, triangular, rectangular, or other shapes recognizable to skilled artisans.

In some situations, the sealing mechanism 20 may also lock the telescoping chamber 12 by locking relative movement between the first tube 14 and the second tube 16. An additional sliding seal 22 may be incorporated into the sealing mechanism 20 or retaining ring, as best viewed in FIG. 1B.

Those having ordinary skill in the art will recognize mechanisms for the locking function as well as elements that may be used for the sealing mechanism 20 and/or the sliding seal 22. Locking relative movement between the first tube 14 and the second tube 16 may assist in shaking the cleaner 10, such that the cleaning solution is somewhat more effective in cleaning the smoking apparatus inserted into the cleaner 10. The first tube 14 may be threaded to hold the sealing mechanism 20 or there may be a snap or click fit, as will be recognized by skilled artisans.

In general, the consumer may simply shake the cleaner 10 for approximately 30 seconds, to activate the cleaning solution. Skilled artisans will recognize proper times for shaking, or letting the cleaner 10 sit, relative to achieving a cleaned apparatus. A basket 24 within the telescoping chamber 12 may hold the smoking apparatus within the telescoping chamber 12. The basket 24 may include a handle, as best viewed in FIG. 1C, which may be flexible.

A first cap 30 or top cap may be opened to add the solvent or cleaning solution to the telescoping chamber 12. Note that some versions or configurations of the cleaner 10 may only have the first cap 30. The upper portion of the second tube 16 may be threaded to interact with the first cap 30 or it may have a snap or click fit. Note that where the second tube 16 is not substantially round or cylindrical, the first cap 30 may be attached to a flange or other structure that makes a substantially round attachment feature.

A second cap 32 or bottom cap, which may or may not be smaller than the first cap 30, may be opened after shaking the cleaner 10. The second cap 32 is best viewed in FIG. 1B. Note that the second cap 32 may allow the user or consumer to rinse the cleaned smoking apparatus. For example, and without limitation, the user may rinse the cleaned smoking apparatus under warm water in a sink, such that the water, resin, and cleaning solution is substantially flushed from the telescoping chamber 12.

The second cap 32 may be smaller, such that the opening on bottom concentrates the exit of the cleaning fluid after each use and allows water to be flushed out under the faucet or similar device. The materials of the cleaner 10 may be formed from any suitable material, including, without limitation, multiple types of plastic, as would be recognized by those having ordinary skill in the art.

The larger opening of the first cap 30 top of the cleaner allows the smoking apparatus in the basket 24, or mesh basket 24, to easily receive the RESIN CLEANSE solution from a purchased pouch, which may be, without limitation, 16 or 24 ounces. The telescoping chamber 12, when fully extended, may be configured to hold, without limitation, 16 ounces or more of the cleaning solution.

### Vibrating Base with Extendable Basket

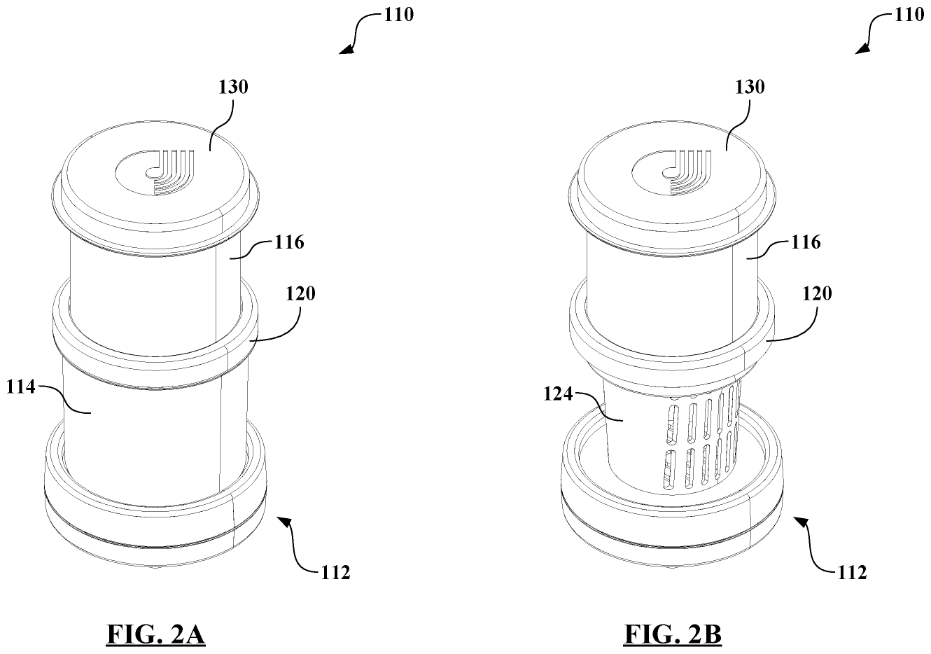

FIG. 2A and FIG. 2B show a smoking apparatus cleaner 110, or simply cleaner 110. This cleaner 110 may use a vibrating, spinning, or oscillating base 112 to assist in cleaning the smoking apparatus, not shown, which is placed inside. The cleaner 110 is generally cylindrical, telescoping, and holds the solvent or cleaning solution.

Skilled artisans will recognize mechanisms for creating the oscillating base 112. These include, without limitation, spinning motors, vibratory bases, or oscillating magnets. As an additional option, the oscillating base 112 may include an electromagnet that interacts with a magnet attached to the basket, such that the electromagnet causes the basket to oscillate up and down as it is pulsed on and off. The up and down oscillation, like the vibration, will encourage cleaning of the smoking apparatus within the basket. As used in herein, the oscillating base 112 refers to any of these options or any that will be recognized by those having ordinary skill in the art.

Like the cleaner 10, the cleaner 110 includes a telescoping chamber in one or more embodiments, which is defined by, at least, a first tube 114 or base chamber and a second tube 116 or top chamber, that give the telescoping chamber variable height. The first tube 114 and the second tube 116 may not be tubular, or cylindrical, but may have different shapes.

A sealing mechanism 120 or retaining ring may join the first tube 114 and the second tube 116. In some situations, the sealing mechanism 120 may also lock the telescoping chamber by locking relative movement between the first tube 114 and the second tube 116. An additional sliding seal may also be incorporated into the sealing mechanism 120 or retaining ring but is not shown.

Those having ordinary skill in the art will recognize mechanisms for the locking function as well as elements that may be used for the sealing mechanism 120 and/or a sliding seal (not shown). Locking relative movement between the first tube 114 and the second tube 116 may assist in shaking the cleaner 110, such that the cleaning solution is somewhat more effective in cleaning the smoking apparatus inserted into the cleaner 110. The first tube 114 may be threaded to hold the sealing mechanism 120 or there may be a snap or click fit, as will be recognized by skilled artisans.

In general, the consumer may place the cleaner 110 onto the oscillating base 112 and allow it to oscillate, vibrate, or otherwise work for some amount of time, to activate the cleaning solution. Skilled artisans will recognize proper times for letting the cleaner 110 sit on the oscillating base 112, relative to achieving a cleaned smoking apparatus.

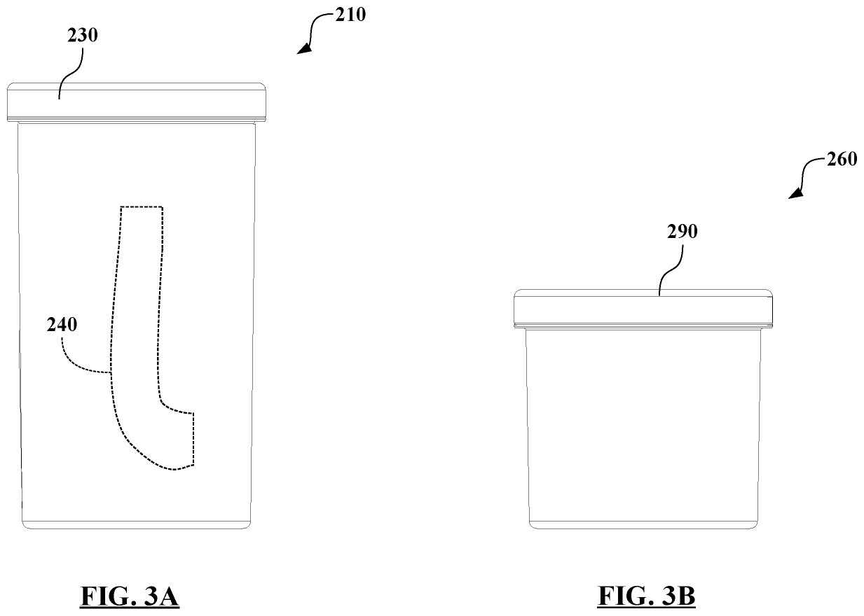

A basket 124 within the telescoping chamber may hold the smoking apparatus within the telescoping chamber. The basket 124 may include a handle, which is not shown in FIGS. 3A and 3B.

A first cap 130 or top cap may be opened to add the solvent or cleaning solution to the telescoping chamber. Note that some versions or configurations of the cleaner 110 may only have the first cap 130. Alternatively, a second cap may be included on the bottom of the first tube 114 to assist in rinsing the telescoping chamber after the smoking apparatus has been cleaned.

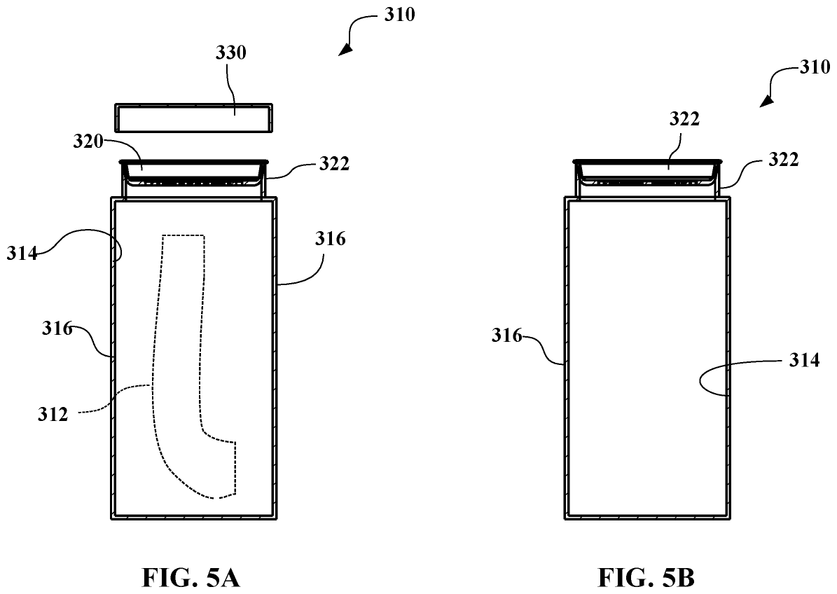

FIGS. 5A and 5B schematically illustrate a front view of a single chamber larger cup 210 and a single chamber smaller cup 260. These may be referred to as fixed chambers. The larger cup 210 has a lid or cap 230 and the smaller cup 260 has a lid or cap 290. FIG. 2A also illustrates, highly schematically, an example smoking apparatus 240 in dashed lines.

For example, and without limitation, the larger cup 210 may be approximately 16 fluid ounces or larger and the smaller cup 260 may be approximately 8 fluid ounces or larger. The volume is expressed, generally, relative to the amount of cleaning solution that can fit inside. Note that both the larger cup 210 and the smaller cup 260 may have baskets inside, which may have handles (neither of which is shown) that are collapsible or removable.

### Alternative Smoking Apparatus Cleaner

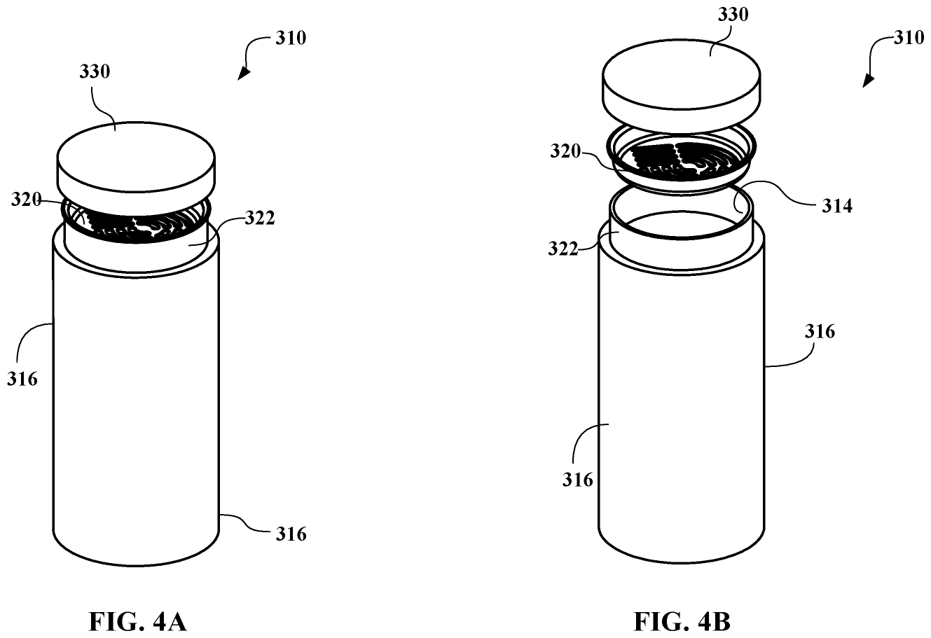

FIGS. 4A and FIGS. 4B show an alternative smoking apparatus alternative cleaner 310, or simply alternative cleaner 310. This alternative cleaner 310 may use shaking to assist in cleaning a smoking apparatus 312, shown schematically in FIG. 5A, which is placed inside of the alternative cleaner 310.

The alternative cleaner 310 is generally cylindrical and holds a solvent or cleaning solution, which is not shown in the figures. The solvent or cleaning solution may be, for example, and without limitation, an all-natural, kosher, environmental, cleaning solvent to clean smoking apparatuses 312. The cleaning solution, for the smoking apparatus 312, may be referred to as RESINCLEANSE or RESIN CLEANSE. The smoking apparatus 312, or smoking apparatuses 312, may be of any kind, including, without limitation, tobacco, cannabis, vape devices, or other devices recognizable to those having ordinary skill in the art. Additionally, the smoking apparatus 312 may be formed from, without limitation, metal, glass, or other materials recognizable to skilled artisans. One of the reasons, without limitation, that the smoking apparatus 312 may need to be cleaned may be a buildup of resin caused by use of the smoking apparatus 312.

The alternative cleaner 310 in one or more embodiments includes a chamber 314, which is defined by, at least, a first tube 316. Note that the first tube 316 may not be tubular, as generally shown in the figures, but may be, without limitation, triangular, rectangular, or other shapes recognizable to skilled artisans. Additional tubes may define the chamber 314, including telescoping tubes with the possibility of locking mechanisms joining the tubes.

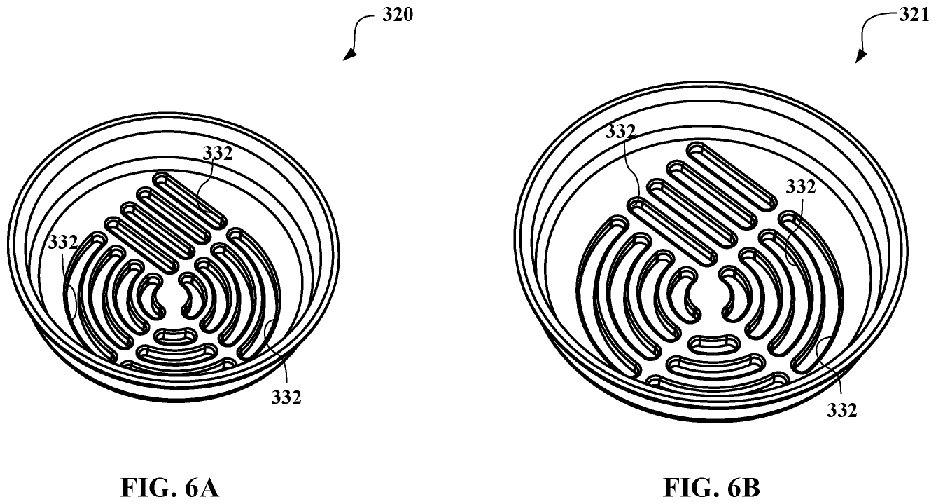

A strainer 320, which may be of varying size, as shown in FIGS. 6A and FIGS. 6B is attached to the first tube 316. A neck 322 extends upward from the first tube 316. Note, however, that the first tube 316 may not include the neck 322 and the strainer 320 may simply seat within the first tube 316.

In general, the consumer may simply shake the alternative cleaner 310 for about, without limitation, 30 seconds, to activate the cleaning solution or solvent. Skilled artisans will recognize proper times for shaking, or letting the alternative cleaner 310 sit, relative to achieving a cleaned smoking apparatus 312. This may be referred to as a period of time for cleaning the smoking apparatus 312 during which cleaning occurs. Note that, in some cases, the alternative cleaner 310 may be placed on an oscillating base, such that the shaking is provided by the oscillating base.

A first cap 330 or top cap may be opened to add the solvent or cleaning solution to the chamber 314. The first cap 330 may clip or snap onto the first tube 316 or the neck 322. Note that some versions or configurations of the alternative cleaner 310 may only have the first cap 330. FIG. 4A shows the alternative cleaner 310 with the first cap 330 floating above and FIG. 4B shows an exploded view of the alternative cleaner 310, such that you can view the strainer 320 inserted into the neck 322.

In situations where the first tube 316 is not cylindrical, the neck 322 may be needed to provide a screw, or threaded area, for the first cap 330. However, the first cap 330 may also simply snap or push onto the neck 322, or first tube 316, such that no screw or thread mechanism is needed.

A second cap or bottom cap, not shown, may or may not be smaller than the first cap 330, may be opened after shaking the alternative cleaner 310 to drain the cleaning solvent. Note that the second cap may allow the user or consumer to rinse the cleaned smoking apparatus 312. For example, and without limitation, the user may rinse the cleaned smoking apparatus 312 under warm water in a sink, such that the water, resin, and cleaning solution is substantially flushed from the chamber 314. The second cap may be smaller, such that the opening on, generally, the bottom concentrates the exit of the cleaning fluid after each use and allows water to be flushed out under the faucet or similar device.

The materials of the alternative cleaner 310 may be formed from any suitable material, including, without limitation, multiple types of plastic, as would be recognized by those having ordinary skill in the art. Placing strainer 320 on top of the alternative cleaner 310 allows the chamber 314 to easily receive the RESIN CLEANSE solution from a purchased pouch, which may be, without limitation, 16 or 24 ounces.

The chamber 314 may be configured to hold, without limitation, 316 ounces or more of the cleaning solution. Depending on the needs of the user of the alternative cleaner 310, the chamber 314 may be substantially, or only partially, filled with the cleaning solvent. Skilled artisans will recognize the amount of cleaning solvent necessary, based on the type of smoking apparatus 312 and the number of smoking apparatuses 312 within the chamber 314.

FIGS. 6A and FIGS. 6B schematically illustrate two exemplary sizes of strainer elements. The strainer 320 may be a first strainer 320 and there is also shown a second strainer 321. Note that there are several slots 332 shown in the figures. The slots 332 allow the first strainer 320 or the second strainer 321 to be inserted in the first tube 316 and then have the cleaning solution poured through the first strainer 320 or the second strainer 321 to clean the smoking apparatus 312 within the chamber 314, which may be covered by the first cap 330. Note that the second strainer 321 may be inserted into a second tube (not shown) but sized for the larger second strainer 321.

The sizes of the strainers listed herein are exemplary and non-limiting, as will be recognized by those having ordinary skill in the art. The first strainer 320 may be, without limitation, between about 1.75-2.25 inches and may be for about 8 fluid ounce containers. The second strainer 321 may be, without limitation, between about 2.25-2.75 inches and may be for about 312-316 fluid ounce containers. In general, the height of either the first strainer 320 or the second strainer 321 may be between about 0.25-0.65 inches. In general, the first strainer 320 is smaller than the second strainer 321, as shown in FIGS. 6A and FIGS. 6B.

The detailed description and the drawings or figures are supportive and descriptive of the disclosure. Note that the drawings may not be to scale. While some of the best modes and other embodiments for carrying out the disclosure have been described in detail, various alternative designs, configurations, and embodiments exist for practicing the appended claims, as will be recognized by those having ordinary skill in the art.

1. A structure for cleaning a smoking apparatus, comprising:
a first tube;
a second tube, slidably movable relative to the first tube;
a retaining ring joining the first tube to the second tube; and
a basket configured to receive the smoking apparatus therein.

2. The structure for cleaning a smoking apparatus of claim 1, further comprising:
a first cap removably attachable to the second tube; and
a second cap removably attachable to the first tube.

3. The structure for cleaning a smoking apparatus of claim 2, further comprising:
a cleaning solution, wherein the first tube and the second tube are filled with the cleaning solution.

4. The structure for cleaning a smoking apparatus of claim 1, further comprising:
an oscillating base configured to receive the first tube and the second tube when placed thereon.

5. The structure for cleaning a smoking apparatus of claim 4, further comprising:
a cleaning solution, wherein the first tube and the second tube are filled with the cleaning solution.

6. A method of cleaning a smoking apparatus, the method comprising:
filling a first tube, defining a chamber, with a cleaning solution;
placing the smoking apparatus into the cleaning solution; and
agitating the cleaning solution and the smoking apparatus for a period of time.

7. The method of cleaning a smoking apparatus of claim 6, wherein agitating the cleaning solution and the smoking apparatus occurs via shaking.

8. The method of cleaning a smoking apparatus of claim 7, wherein agitating the cleaning solution and the smoking apparatus occurs via an oscillating base.

9. The method of cleaning a smoking apparatus of claim 6, wherein the first tube, and the chamber defined thereby, includes:
extending a two-part telescoping tube; and
filling the telescoping tube with a cleaning solution.

10. The method of cleaning a smoking apparatus of claim 9, wherein agitating the cleaning solution and the smoking apparatus occurs via shaking.

11. The method of cleaning a smoking apparatus of claim 10, further comprising:
placing the telescoping tube on an oscillating base, wherein agitating the cleaning solution and the smoking apparatus occurs via vibration, spinning, or oscillation from the oscillating base.

12. A structure for cleaning a smoking apparatus, comprising:
a first tube, defining a chamber;
a first strainer; and
a cleaning solution, wherein the chamber is filled with the cleaning solution.

13. The structure for cleaning a smoking apparatus of claim 12, further comprising:
a first cap removably attachable to the first tube.

14. The structure for cleaning a smoking apparatus of claim 13, further comprising:
a neck formed on the first tube, wherein the first cap attaches to the neck.

15. The structure for cleaning a smoking apparatus of claim 14, further comprising:
a cleaning solution,
wherein the first tube is filled with the cleaning solution, and
wherein the smoking apparatus is placed into the first tube and agitated within the cleaning solution.

16. The structure for cleaning a smoking apparatus of claim 12, further comprising:
a second strainer, wherein the first strainer is smaller than the second strainer.

17. The structure for cleaning a smoking apparatus of claim 16, further comprising:
a second tube, wherein the first tube is smaller than the second tube, and the second strainer fits the second tube.

18. The structure for cleaning a smoking apparatus of claim 17, further comprising:
wherein the second tube is filled with the cleaning solution, and
wherein the smoking apparatus is placed into the second tube and agitated within the cleaning solution.
